(19) United States
(12) Patent Application Publication
(10) Pub. No.: US 2001/0032125 A1
(43) Pub. Date: Oct. 18, 2001

(54) Activation of coupons based on quiz or questionnaire

(76) Inventors: Sundeep Bhan, Pawing, NY (US); Sameer M. Shariff, New York, NY (US); Richard J. Morello, Boston, MA (US)

Correspondence Address: Robert S. Mayer, Esq., LYON & LYON LLP, Suite 4700, 633 W. Fifth Street, Los Angeles, CA, 90071, US

(21) Appl. No.: 09/737,616

(22) Filed: Dec. 15, 2000

Related U.S. Application Data
(60) Provisional application No. 60/172,688, filed on Dec. 20, 1999.

(51) Int. Cl. G06F 17/60

(52) U.S. Cl. 705/14; 705/10; 434/332

(57) ABSTRACT

Information is provided to a participant, and a quiz or questionnaire about the provided information is subsequently administered. In the quiz embodiment, the participant receives a reward (such as a credit at an on-line shopping web site) if the performance on the quiz is adequate. Tying the reward to adequate performance on the quiz ensures that the information provided has been adequately learned. In the questionnaire embodiment, the participant receives a reward for answering all of the questions. Preferably, incorrect answers are corrected to promote learning of the information. In a preferred embodiment, a coupon is used to invite participation in the program, and the Internet is used to transmit the information, the quiz or questionnaire, and the answers.

### CROSS-REFERENCE TO RELATED APPLICATIONS

Priority is claimed to U.S. provisional application No. 60/172,688, filed Dec. 20, 1999, which is incorporated herein by reference.

### FIELD OF THE INVENTION

The field of the present invention relates to marketing products by providing information to a target audience and ensuring that the product information has been read and, optionally, learned. In particular, some embodiments of the present invention relate to providing product information to a participant, administering a quiz to determine whether the information has been satisfactorily learned by the participant, and providing a reward to the participant for learning the information. Other embodiments of the present invention relate to providing product information to a participant, administering a questionnaire to the participant, and providing a reward to the participant for answering the questionnaire.

While the present invention may be used to market to any type of product, it is particularly useful when the sale, dispensation, or recommendation of a particular product requires professional expertise or detailed knowledge about the product. The prescribing of pharmaceuticals or medical devices by doctors is an example of such a situation, and the preferred embodiments are described herein in that context. Of course, the invention may be applied in other contexts as well.

### BACKGROUND OF THE INVENTION

It has been estimated that pharmaceutical companies spend over 8 billion dollars a year marketing drugs through various vehicles. Traditionally, efforts to market pharmaceuticals have been aimed either directly at potential end users of the drugs or at doctors who prescribe drugs. Of these two approaches, vastly more resources are spent on marketing aimed at doctors.

The process of getting a person to learn written information can be divided into three phases: disseminating the information to the person, getting the person to read the written information, and getting the person to understanding the information that was read.

One traditional way that pharmaceutical companies market their products to doctors is by running advertisements in selected media that doctors are likely to read, such as medical journals. Advertisements of this type may be targeted to doctors that practice in particular specialties by placing ads in appropriate journals. Another traditional way to market products to doctors is to obtain a mailing list of doctors that practice in a desired specialty, and to mail product information to those doctors. While both of these approaches can be successful in getting the product information into the hands of the doctor, these approaches do not address the final two phases of getting the doctor to read and understand the information.

Another traditional way that pharmaceutical companies market their products to doctors is through sales representatives who are hired to disseminate information about the companies' products. Using sales representatives has traditionally been an excellent way to get product information into the hands of the relevant doctors, because sales representative can tailor their presentation to the individual doctor being visited. Sales representatives can also establish a personal relationship with the doctors that they visit, and explain the benefits of their clients' products to the doctors in person. But due to the complex nature of many pharmaceuticals and medical devices, and the short amount of time that most doctors usually spend with sales representatives, sales representative usually supplement their visits with written information about the products. As a result, marketing pharmaceuticals using sales representatives can suffer from the same problems as placing ads in medical journals, because the final two phases of getting the doctor to read and understand the information are not addressed.

Moreover, even when conventional marketing approaches succeed in getting a doctor to read information that has been provided, these approaches do not address the final phase of understanding (or absorption). This phase is particularly important in the pharmaceutical field for a number of reasons. First, lack of absorption can result in lost opportunities for the treatment of certain conditions with certain drugs, which deprives the benefits of the drugs from the patients, and also deprives the benefits of making a sale from the pharmaceutical companies. Second, and more importantly, an incorrect understanding of certain product information could result in the improper prescribing of a drug, which might cause harm to a patient (e.g., when a certain drug interacts negatively with another drug, or when a certain drug is only appropriate for certain types of patients). Third, a more complete understanding of product information enables doctors to better evaluate potential risks and dangers to patients.

In short, with traditional marketing methods, it can be difficult to determine when product information provided to doctors has been read and when it has been absorbed. As a result, patients may miss out on the products' benefits, and large portion of the expended marketing resources may be wasted.

### SUMMARY OF THE INVENTION

An object of the present invention is to ensure that information provided to participants is actually read. In certain embodiments of the present invention, another object is to ensure that the information is learned (or absorbed).

These objects are accomplished by providing information to the participant and subsequently administering either a quiz or a questionnaire about the provided information. When a quiz is administered, the participant will receive a reward if the participant's performance on the quiz is adequate, which ensures that the provided information has actually been absorbed. When a questionnaire is administered, the participant receives a reward for answering all of the questions, regardless of whether the answers are correct. This improves the chances that the information will be read and absorbed.

The present invention is particularly suited to situations where proper use of the product involves professional expertise or detailed knowledge about the product, such as drugs or medical devices that are prescribed by doctors.

In one preferred embodiment, a coupon or certificate is used to invite a participant to log on to an Internet web site. A remote Internet server provides product information to the participant, followed by a quiz or questionnaire about the provided information. When a quiz is administered, after the participant answers the quiz and submits the answers to the remote Internet server, the server grades the quiz to determine whether the participant has learned the information. If a sufficiently high grade has been achieved, the participant is rewarded by, for example, providing a credit at an on-line shopping web site. When a questionnaire is administered, the server provides the reward if all the questions have been answered, regardless of whether they have been answered correctly.

One aspect of the invention relates to a method of promoting a product or service. In this method, a user is invited to visit a web site, and material that promotes the product or service is presented to the user when the user visits the web site. Questions that relate to the presented material are presented to the user. Responses to the presented questions are accepted from the user, and a determination of whether a sufficient number of the responses are correct is made. If a sufficient number of the responses are correct, a reward is provided to the user.

Another aspect of the invention relates to a method of promoting a product or service. In this method, material that promotes the product or service is presented to the user when the user visits a web site, and a question that relates to the presented material is presented to the user. A response to the presented question is accepted from the user, and the accepted response is checked for correctness. If the response is correct, a reward is provided to the user.

Another aspect of the invention relates to a method of promoting a product or service. In this method, a user is invited to visit a web site, and material that promotes the product or service is presented to the user when the user visits the web site. Questions that relate to the presented material are presented to the user. Responses to the presented questions are accepted from the user, and the system determines whether a response to each of the questions has been accepted. When an accepted response is incorrect, the user is notified. If a response to each of the questions has been accepted, a reward is provided to the user.

### BRIEF DESCRIPTION OF THE DRAWINGS

FIG. 1 is a sketch of a coupon that can be used in connection with a first embodiment.

FIG. 2 is a schematic illustration of a suitable computer setup used with the first embodiment.

FIG. 3 is a flowchart that depicts processes performed in the first embodiment.

FIG. 4 is an illustration of an initial instruction screen on a web site in the first embodiment.

FIG. 5 is an example of a coupon redemption screen of the first embodiment.

FIG. 6 is an example of a product information screen of the first embodiment.

FIG. 7 is an example of a quiz used in the first embodiment.

FIG. 8A is an example of a screen displayed after successful completion of a quiz in the first embodiment.

FIG. 8B is an example of a screen displayed after an unsuccessful completion of the quiz in the first embodiment.

FIG. 9 is a flowchart that depicts processes performed in a second embodiment.

### DETAILED DESCRIPTION OF THE PREFERRED EMBODIMENTS

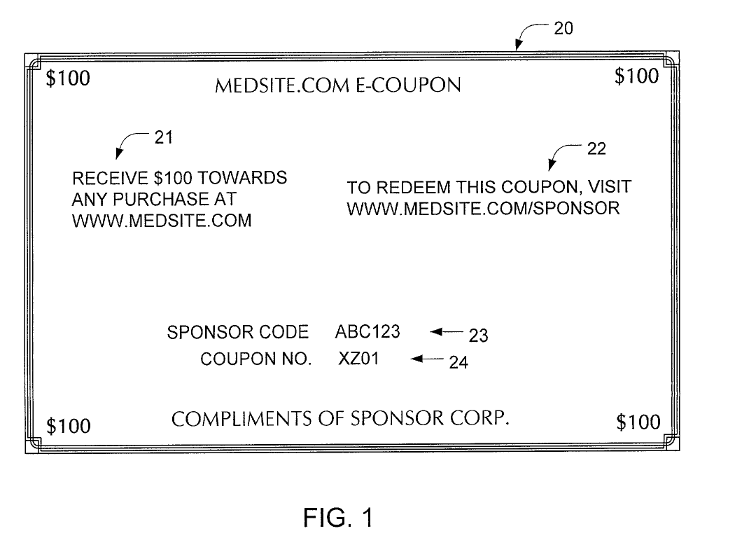

FIG. 1 is an example of a suitable coupon 20 for use with a first embodiment of the present invention. In this embodiment, the coupon 20 is first distributed and subsequently redeemed.

The coupon 20 illustrated in FIG. 1 may be printed on any suitable material such as paper or plastic, and includes a first field 21 that describes a reward that will be obtained when the coupon is ultimately redeemed. Examples of suitable rewards include a credit at a medical bookstore web site (e.g., $100, which is permitted under the AMA code of ethics as a complementary medical honorarium), or a particular medical book or supply selected by the coupon's sponsor (e.g., a stethoscope). It also includes a second field 22 with instructions on how to redeem the coupon 20. Preferably, these instructions 22 provide an Internet address (i.e., a URL) which can be visited by the doctor to redeem the coupon. In embodiments where coupons are distributed electronically, (e.g., via email or via the Internet) this URL may be accessed by clicking on a suitable hypertext link.

The illustrated coupon 20 also includes a sponsor code 23. Preferably, the sponsor code 23 is encoded to identify the sponsor (i.e., the company that issued the coupon), and the particular product being promoted by the coupon. Optionally, information that identifies a geographical region and/or the particular sales representative who distributed the coupon may also be encoded in the sponsor code 23. This information in the sponsor code 23 may be encoded in a single field 23 as illustrated, which can be used as an index into a database that identifies the sponsor, product, region, and sales rep corresponding to each sponsor code. Alternatively, the sponsor code may be divided into a plurality of individual sub-fields (with, e.g., individual sub-fields to identify the sponsor, product, region, and sales rep), and the entry in each subfield may be used as an index into a suitable database that is indexed by subfields. As yet another alternative, instead of providing a number of sub-fields within a single contiguous sponsor code field, the sub-fields may be printed on the coupon 20 in a plurality of non-contiguous individual fields (not shown).

Additional information may also be encoded in the sponsor code, in accordance with the requirements of the particular marketing plan being implemented using the coupon 20. For example, if the database is suitably programmed, the sponsor code 23 may be used to determine that a given coupon was distributed during a particular day of a particular trade show. Such information could then be used to measure the effectiveness of the sales representatives that were working on that particular day. This additional information may be accessed using the same sponsor code 23 which is used to index into the database, or in a subfield of the sponsor code (not shown) that is used to index into a supplemental database.

Preferably, each coupon 20 also includes a coupon number 24, which functions as the serial number for the coupon. In an alternative preferred embodiment, the coupon number and the sponsor code may be combined into a single field, and the relevant information can be extracted therefrom using a suitable lookup table, where the value of the combined field is used as an index into the lookup table.

Initially, an appropriate coupon is distributed to a targeted doctor. Coupon distribution may be accomplished by having sales representatives hand the coupons to doctors in person at the doctors' offices. Alternatively, the coupons may be handed out at trade shows or conferences, placed in advertisements in medical journals, distributed by ordinary mail or e-mail, or distributed in any other suitable manner. Coupons may also be distributed electronically on appropriate Internet web sites.

Preferably, when coupons are distributed by sales representatives, the coupons are encoded (e.g., in the sponsor code, as described above, or in the coupon number) with information that can be used to identify the particular sales representative that distributed the coupon. This can be accomplished, for example, by printing out a stack of coupons with a common sales representative ID number, and keeping track of the particular sales representative to whom the stack was provided. Optionally, the sales representative may be asked to associate his or her name with a particular sales representative ID number by visiting a web page set up for this purpose.

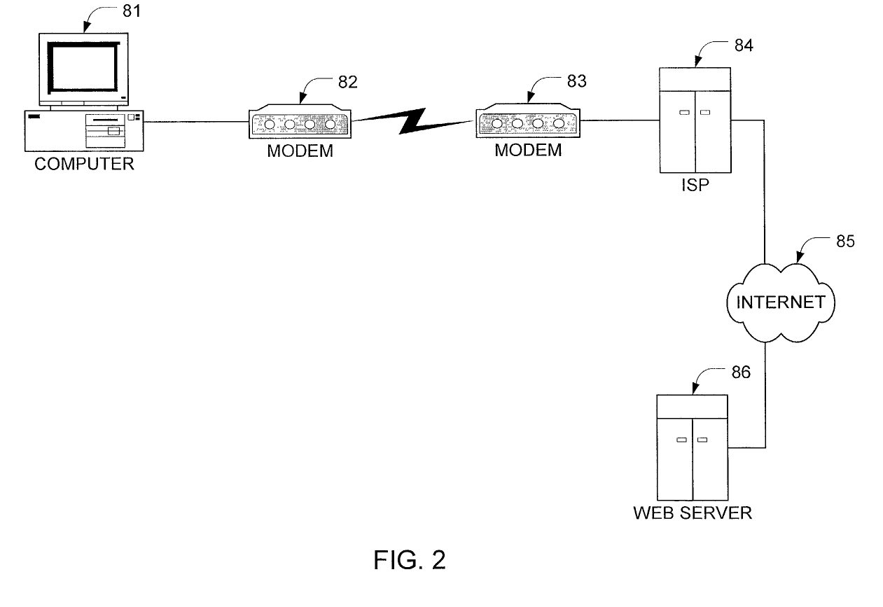

FIG. 2 is an example of a data communication setup that can be used to redeem coupons that have been previously distributed. The illustrated setup is preferably implemented using a conventional computer 81 (e.g., an IBM™ PC compatible or an Apple™ iMac) running a suitable browser (e.g., Netscape™ Navigator). A connection with the Internet may be established using any of a variety of techniques well known to those skilled in the art, including, for example, using modems 82, 83 to communicate with an Internet Service Provider (ISP) 84, which communicates with the web server 86 via the Internet 85. Optionally, particularly when the coupons are provided at a tradeshow, a dedicated computer that is accessible to the visiting public may be provided for the purpose of coupon redemption.

When a doctor wishes to redeem a coupon of the type illustrated in FIG. 1, the doctor follows the instructions 22 printed on the coupon 20 and visits the coupon redemption web site (whose URL is preferably printed on the coupon 20).

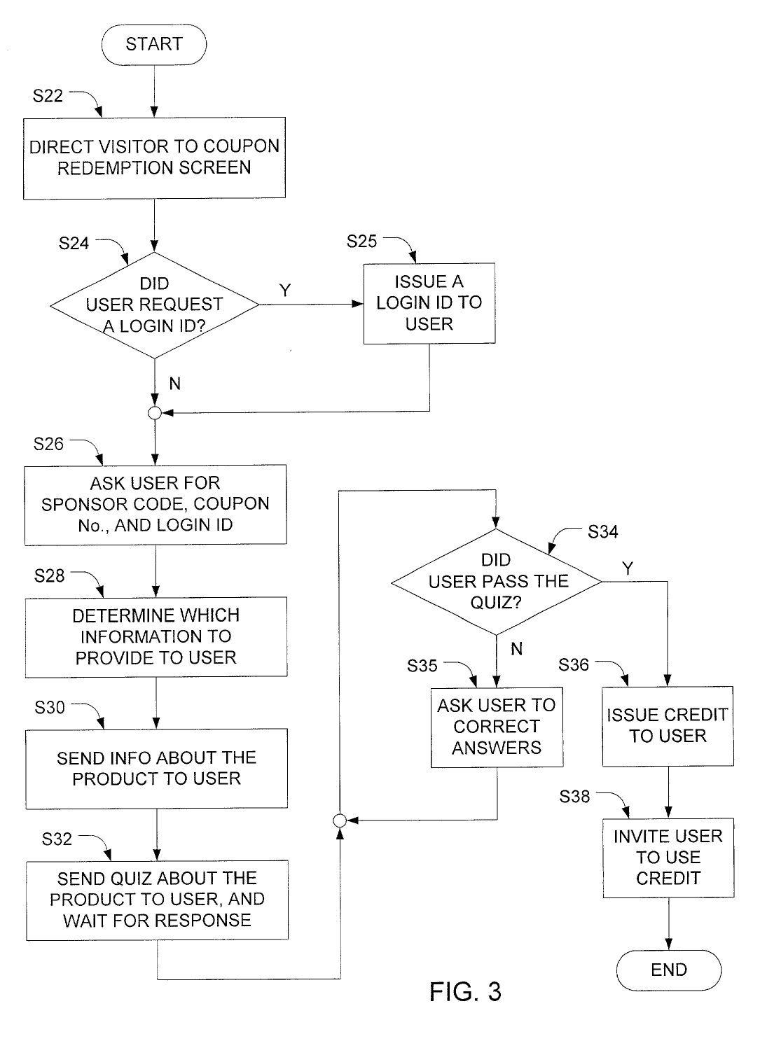

FIG. 3 is a flowchart of the processes implemented at the web server 86 once a doctor logs on to the appropriate web site by, for example, accessing the URL printed on the coupon 20. Optionally, the URL on the coupon may direct the doctor to a web page that is dedicated to a single drug (e.g., www.medsite.com/drugname), dedicated to a single drug company (e.g., www.medsite.com/sponsorname), dedicated to coupon redemption only (e.g., www.coupon.medsite.com), or a non-dedicated web page (e.g., www.medsite.com).

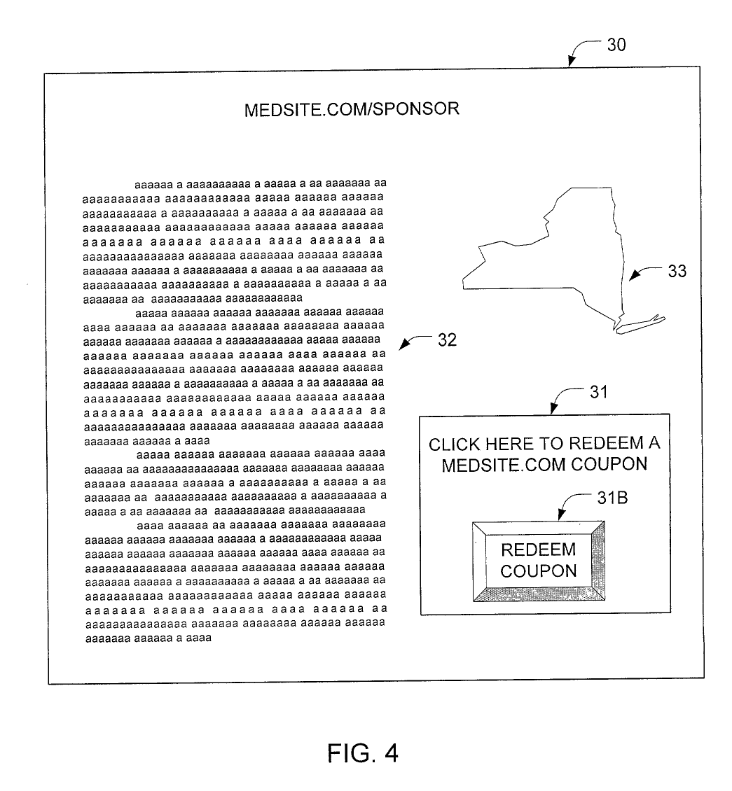

The URL on the coupon may be used to direct the doctor to an initial instruction screen 30, which may be co-sponsored by a drug company and the web site operator. FIG. 4 is an example of a suitable initial instruction screen 30. Sending the doctor to an initial instruction screen 30 can provide sponsor companies with additional marketing opportunities before the coupon is actually redeemed. These additional marketing opportunities may be implemented by providing any desired type of information to the doctor using, for example, the regions 32 and 33. The initial instruction screen 30, as well as the other display screens described herein, are preferably created by the web browser running on the doctor's computer 81 based on an html (hypertext markup language) message provided by the web server 86. The web server 86 may be programmed in any suitable way so as to produce the desired html message.

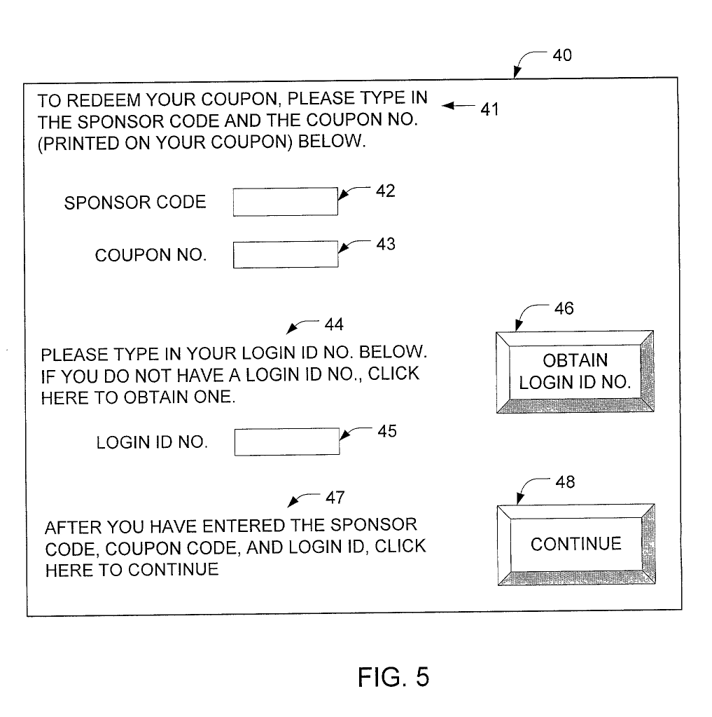

The initial instruction screen 30 also contains a region 31 that is used to implement step S22, where the coupon redemption process is initiated. In the illustrated example, when the doctor clicks on a button 31B within the region 31, the doctor's web browser will be directed to a coupon redemption screen 40 (shown in FIG. 5). In those embodiments where the URL on the coupon sends the doctor directly to a dedicated web page, step S22 is skipped, and the doctor will arrive directly at the coupon redemption screen 40 (without requiring a click on the initial instruction screen 30). Optionally, the sponsor code may even be incorporated into the URL, so that the doctor can be sent directly to a redemption page custom-designed for a specific coupon.

Returning now to FIG. 3, steps S24, S25, and S26 implement the processing associated with FIG. 5, which is an example of a suitable coupon redemption screen 40. Preferably, the coupon redemption screen 40 includes instructions 41 requesting that the doctor enter the sponsor code and the coupon number in fields 42, 43 provided for this purpose. While the FIG. 5 embodiment includes fields for the sponsor code 42 and the coupon number 43, alternative field arrangements would be used when alternative field arrangements are used on the coupon itself (as described above).

The coupon redemption screen 40 also includes instructions 44 asking the doctor to type in his or her log-in ID number in a field 45 provided for this purpose. Preferably, the log-in ID is used as an index into a database that stores the area of practice for each doctor. Optionally, a history of visits to the coupon redemption site for each doctor may be indexed using the log-in ID. As yet another option, a password (not shown) that is associated with the log-in ID may also be requested at this point.

If the doctor does not have a log-in ID number, the doctor is invited to click on a button 46 to obtain a log-in ID. When the doctor clicks on the button 46 to request a log-in ID, the result of the test performed in step S24 will be YES, and processing will proceed to step S25 where a log-in ID is issued to the doctor. Preferably, in order to obtain a log-in ID, the doctor will have to provide his or her name, address, telephone number, and a list of areas of practice. Alternatively, when a suitable database of doctors is available, some of this information may be obtained from that database. In alternative preferred embodiments, log-in information is not obtained in advance. Instead, the doctor's name and address are requested at the end of the quiz-taking process.

Instructions 47 prompt the doctor to click on a button 48 after the sponsor code 42, coupon number 43, and the log-in ID number 45 have been entered (thereby implementing step S26). When the doctor clicks on the continue button 48, processing will proceed to step S28.

In step S28, the web server 86 decides which information to send to the doctor. This may be accomplished using the sponsor code 42 that was entered by the doctor on the coupon redemption screen 40, which enables a particular coupon to be used to market a particular product. Alternatively, the determination of which information to send may be based on the specialty of the doctor, which can preferably be determined by indexing into a database using the log-in ID number 45. As yet another alternative, when sufficiently detailed URLs are provided on the coupon, the determination of which information to send may be based on the URL being visited.

As yet another alternative, the determination of which information to send may be based on both the sponsor code 42 and the log-in ID number 45. For example, if a particular drug company makes one drug for treating osteoporosis and a second drug for treating juvenile diabetes, both of these drugs may be marketed using a single coupon with the same sponsor code. When a doctor enters that particular sponsor code, the web server 86 would determine which information to send to that doctor based on the log-in ID number 45. For example, when the doctor associated with the entered log-in ID number is a pediatrician, information about the juvenile diabetes drug would be sent, and when the doctor associated with a log-in ID is a geriatrics specialist, information about an osteoporosis drug would be sent.

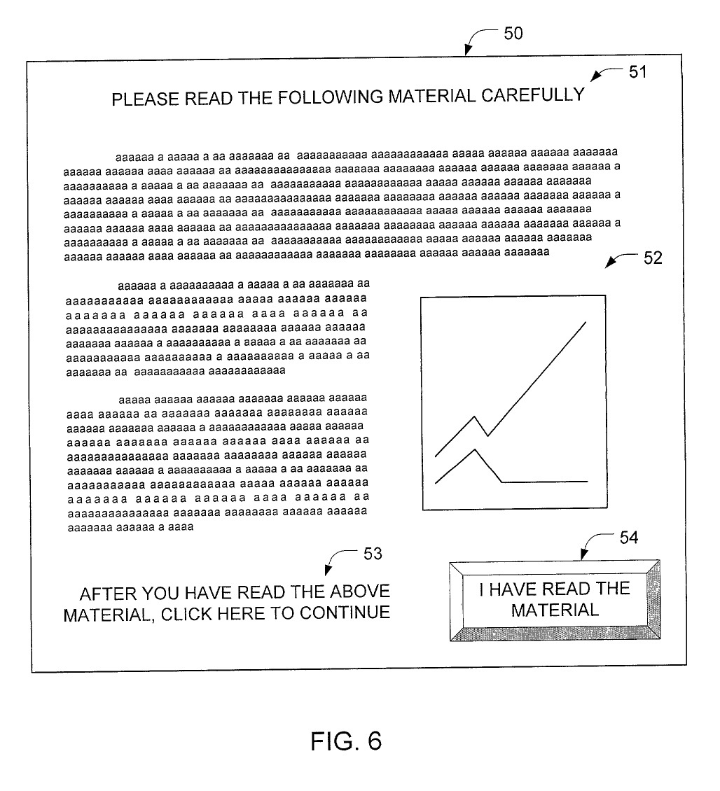

Next, in step S30, information about the product is sent to the doctor. FIG. 6 shows an example screen 50 of such information. Preferably, this screen includes instructions 51 asking the doctor to read the information, and information content 52, which may optionally include pictorial and/or graphic information. The information screen 50 preferably includes instructions 53 asking the doctor to click on a button 54 after the doctor has read the information 52. Optionally, scroll bars may be provided (on this and other screens) if the information is too big to fit on the computer's 81 display screen. After the doctor has indicated that he or she has read the information, a quiz is provided to the doctor in step S32. In alternative embodiments, the product information 52 may be provided to the doctor off-line by, for example, mailing the information to the doctor or printing the information on the coupon 20 itself.

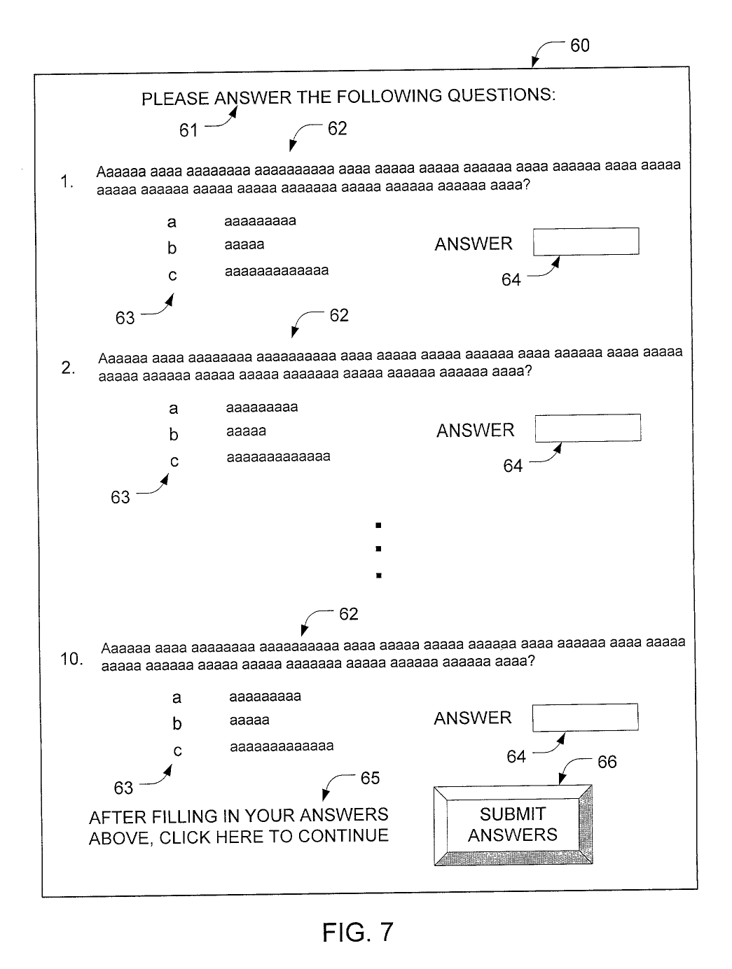

FIG. 7 is an example of a suitable quiz 60. Preferably, the quiz 60 includes instructions 61 requesting that the doctor answer the questions 62. Each question has an answer field 64. After reading each question 62, the doctor fills in the answer in the corresponding answer field 64. The questions 62 may be multiple choice questions, with multiple choice answers 63 provided beneath the question. Alternatively, any other form of questions may be used (e.g., true/false or short answer questions). Instructions 65 prompt the doctor to click on the button 66 to submit the answers to the quiz. In alternative embodiments, the quiz 52 may be provided to the doctor off-line by, for example, mailing the quiz to the doctor or printing the quiz questions 62 on the coupon 20 itself.

Returning now to FIG. 3, after the answers have been submitted by the doctor, processing proceeds to step S34 where a test is performed to determine whether the doctor has passed the quiz. This test may be accomplished, for example, by checking the answers provided by the doctor against a template of correct answers. When short answer questions are used, each question may have more than one correct answer, and each of these correct answers may be included in the template. When long answer questions are used, the correctness of each answer may be analyzed by a human operator or by a suitable artificial intelligence program. The passing grade for the quiz may be constant (e.g., always 80%) or may be specified by the sponsor company for each individual drug.

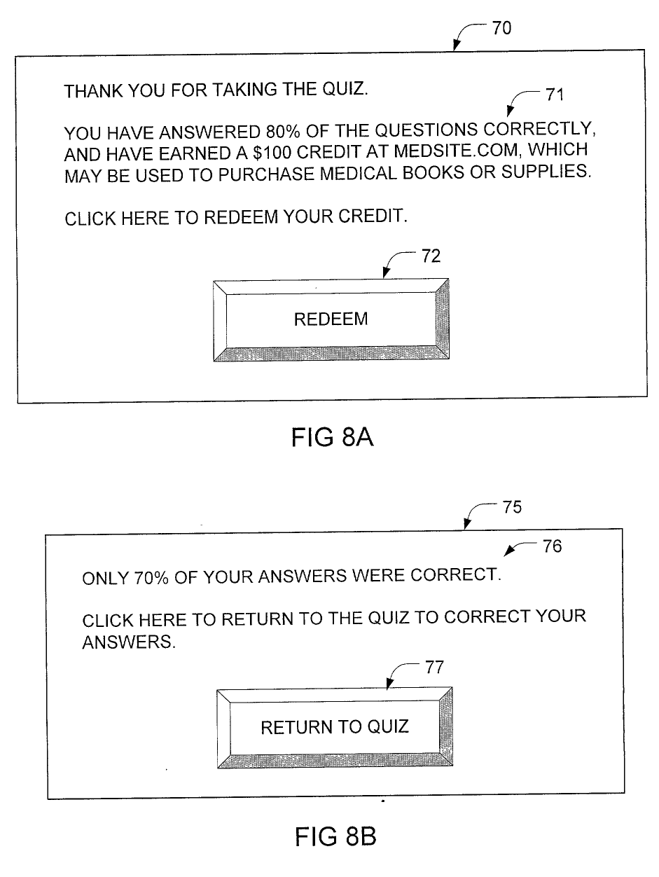

If the doctor passes the quiz, processing continues at step S36 where a reward is provided to the doctor. When the reward is a credit at an online provider (e.g., medsite.com), the doctor is then invited, in step S38, to use the credit. FIG. 8A is an example of a suitable display 70 that may be used to invite the doctor to use the credit. Preferably, this display includes a message 71 informing the doctor that the questions have been answered correctly and that the doctor has earned a credit. It also includes button 72 that will send the browser to a web site or page that is preferably configured to accept the credit issued in step S36. Optionally, additional buttons (not shown) may be provided to direct the doctor to other participating web sites. When other types of rewards are provided (e.g., a specific item selected by the coupon's sponsor), suitable changes to the reward delivery process should be made, such as asking the doctor to specify a shipping address.

If the test in step S34 indicates that the doctor did not pass the quiz, processing proceeds to step S35 where the doctor is asked to correct the answers on the quiz. FIG. 8B shows a suitable display 75 used for this purpose. Preferably, it includes a message 76 informing the doctor that the quiz was not passed, and provides a button 77 for returning to the quiz. If the doctor uses this button 77 to return to the quiz, the doctor will be given a chance to correct all of the incorrect answers on the quiz. Optionally, either the entire quiz or only the incorrectly answered questions may be presented to the doctor in this step S35. Once the doctor has corrected the quiz, processing returns to step S34 where the corrected quiz answers are checked.

In a variation of the first embodiment described above, the quiz questions are provided to the doctor one at a time, and an answer to each question is accepted after that question is presented (instead of providing the questions and accepting the answers in batches). In this variation, an opportunity to fix incorrect answers may be provided instantly, which can make the quiz-taking process more pleasant to the participant.

In another variation of the first embodiment, the quiz is replaced by a questionnaire, and the test to determine whether the participant passed (in step S34) is replaced with a test to determine whether the participant has answered all of the questions (regardless of the correctness of the answers). The questionnaire may be administered in a single batch or one question at a time. Preferably, whenever a question is answered incorrectly, the correct answer is provided to the participant for educational purposes. This feedback should help the doctor to better understand the information being presented.

Optionally, instead of or in addition to asking questions about the information that has been previously provided, questions may be administered to provide sponsor companies with information about doctors' insights and attitudes towards selected drugs or other clinically relevant topics. A sponsor company may then choose to follow up with selected doctors based on their answers to these questions.

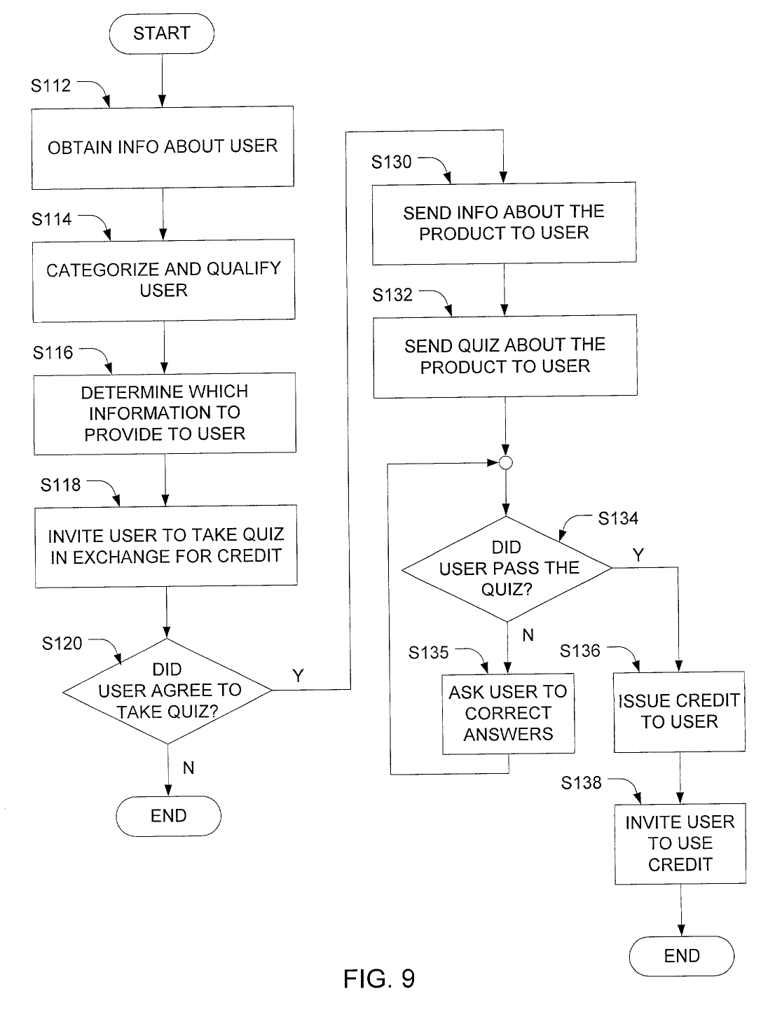

FIG. 9 is a flowchart of the processes implemented in an alternative embodiment that does not rely on a printed coupon. Instead, the FIG. 9 embodiment contemplates that the doctor will contact the web server 86 (shown in FIG. 2) on his or her own accord, or be invited to the web server by, for example, an Internet banner advertisement placed on appropriate web pages. Processing in this embodiment begins at step S112, where the system obtains information about the visiting doctor. A log-in ID number similar to the log-in ID of the first embodiment may be requested, which can be used to determine the doctor's area of practice. Alternatively, the doctor may provide information such as name, address, and areas of practice as described above in connection with step S25 of the first embodiment. In other alternative embodiments, this information may be obtained at the end of the quiz-taking process.

In step S114, the doctor is categorized based on the information provided in step S112 and optionally, qualified to determine if the web server 86 wishes to offer an electronic coupon to the doctor. This qualification may be based, for example, on the particular area of practice of the doctor, or on a database containing information indicating that a particular sponsor company would like to inform this particular doctor about a certain drug.

Next, in step S116, the system determines which information to send to the doctor. Preferably, this is accomplished using the area-of-practice information obtained in steps S112 and S114. Optionally, a record of past transactions for each doctor may be maintained in the database, so that a new presentation may be made each time a particular doctor visits the coupon redemption web site, and to prevent duplicate coupon redemptions for reading the same information. In step S118, the doctor is invited to take a quiz in exchange for a credit. In step S120, a test is performed to determine whether the doctor has agreed to take the quiz. If the doctor has not agreed to take the quiz, processing ends. If the doctor has agreed to take the quiz, processing continues at step S130. The remaining steps S130-S138 of the FIG. 9 embodiment correspond, respectively, to steps S30-S38 of the first embodiment, described above. The variations to the first embodiment (e.g., providing quiz questions one at a time, and providing a questionnaire instead of a quiz) may be applied to this embodiment as well.

While the embodiments described above contemplate a particular user interface that provides information to the doctor by displaying text and pictorial or graphic images, and receives information from the doctor via entries that are typed into input fields and via mouse clicks, alternative user interfaces features may be substituted therefor. Examples of suitable alternative user interface features include the selection of numeric entries from pop-down menus; using hyperlinks to either supplement or replace the button clicks that are used to proceed to other screens; and using voice input and/or output. The implementation of these and numerous other alternative user interface approaches will be apparent to persons skilled in the relevant arts.

In the embodiments described above, a single web site is used as a starting point to market multiple products from one or more pharmaceutical companies. In alternative embodiments, individual web sites may be set up for each individual pharmaceutical company, or even for each individual drug.

Instead of redeeming the coupon 20 via a computer 81 connected to the Internet 85, as described above, the coupon 20 may be redeemed in any number of alternative ways. For example, in one alternative embodiment, a coupon redemption system may be accessed by connecting to a private non-Internet network via modem. In another alternative embodiment, some of the functions that were implemented by the web server 86 in the above-described embodiments may be performed by the computer 81 instead of the web server (provided that the software running on the computer 81 is suitably modified). In another alternative embodiment, coupon redemption may be accomplished using an automated touch-tone or voice response system, implemented using any of a variety of techniques well known to those skilled in the art. In yet another alternative embodiment, coupon redemption may be accomplished using a live operator, by having the operator administer the quiz orally and log the doctor's responses. When any of these alternative coupon redemption methods are used, suitable modifications to the coupon itself and to the above-described coupon redemption process should be made, as will be apparent to those skilled in the art. For example, the coupon would include a telephone number for accessing a telephone-based coupon redemption system instead of a URL.

Of course, while the embodiments described above have been explained in the context of a pharmaceutical company marketing drugs to doctors, these embodiments may be applied to other fields and to other types of participants. For example, medical devices may be marketed to doctors, computers to IT specialists, and test instruments to engineers. The embodiments described above may even be applied in fields where the information provided is less technical. For example, automobile manufacturers could use the embodiments described above to market their products, and plumbers could use them to market their services. Numerous other applications can be readily envisioned.

In addition to ensuring that the provided information is read (or absorbed) by the participants, data from the coupon redemption process of the above described embodiments may be collected and tracked in a marketing database. This database may subsequently be used, for example, to determine which types of products interest particular participants, to improve future marketing efforts, to track the success of a given coupon program, to track the success of a particular sales representative, and to generate reports for companies that sponsor the coupons.

Finally, while the present invention has been explained in the context of the preferred embodiments described above, it is to be understood that various changes may be made to those embodiments, and various equivalents may be substituted, without departing from the spirit or scope of the invention, as will be apparent to persons skilled in the relevant art.

We claim:

1. A method of promoting a product or service, the method comprising the steps of:
inviting a user to visit a web site;
presenting material that promotes the product or service to the user when the user visits the web site;
presenting questions to the user, wherein the questions relate to the material presented in the material-presenting step;
accepting, from the user, responses to the questions presented in the question-presenting step;
determining whether a sufficient number of the responses accepted in the accepting step are correct; and
providing a reward to the user if it is determined, in the determining step, that a sufficient number of the responses are correct.

2. The method of claim 1, wherein the inviting step comprises the step of distributing a tangible object upon which a URL for the web site is printed.

3. The method of claim 1, wherein the inviting step comprises the step of sending an email containing a URL for the web site.

4. The method of claim 1, wherein the sufficient number in the determining step is 100% of the number of questions presented in the question-presenting step.

5. The method of claim 1, wherein the sufficient number in the determining step is about 80% of the number of questions presented in the question-presenting step.

6. The method of claim 1, further comprising the step of selecting the product or service that is promoted from a plurality of products and/or services based on a code provided by the user, wherein the selecting step is implemented prior to the material-presenting step.

7. The method of claim 1, further comprising the steps of:
informing a user when an insufficient number of the responses accepted in the accepting step are correct;
accepting corrected responses to at least one of the questions that were answered incorrectly; and
providing a reward to the user after the corrected responses have been accepted in the corrected-response accepting step.

8. The method of claim 1, wherein the questions in the question-presenting step are all presented during a first interval of time, and
the responses in the accepting step are all accepted during a second interval of time that follows the first interval of time.

9. The method of claim 1, wherein the questions in the question-presenting step are presented individually, and the response for each respective question is accepted in the accepting step before any subsequent questions are presented.

10. The method of claim 1, wherein the questions in the question-presenting step are presented individually,
wherein the response for each respective question is accepted in the accepting step before any subsequent questions are presented,
wherein a determination of correctness is made in the determining step for each accepted response before any subsequent questions are presented,
wherein the user is informed when an accepted response is incorrect before any subsequent questions are presented, and wherein a corrected response is accepted before any subsequent questions are presented.

11. The method of claim 1, further comprising the step of tracking, in a database, the responses accepted in the accepting step.

12. The method of claim 1, wherein the questions presented in the question-presenting step are multiple-choice questions.

13. A method of promoting a product or service, the method comprising the steps of:
presenting material that promotes the product or service to the user when the user visits a web site;
presenting a question to the user, wherein the question relates to the material presented in the material-presenting step;
accepting, from the user, a response to the question presented in the question-presenting step;
determining whether the response accepted in the accepting step is correct; and
providing a reward to the user if it is determined, in the determining step, that the response is correct.

14. The method of claim 13, further comprising the step of inviting a user to visit the web site, wherein the inviting step is performed prior to the material-presenting step.

15. The method of claim 13, further comprising the steps of:
informing a user when the response accepted in the accepting step is incorrect;
accepting a corrected response to the presented question; and
providing a reward to the user after the corrected response has been accepted in the corrected-response accepting step.

16. A method of promoting a product or service, the method comprising the steps of:
inviting a user to visit a web site;
presenting material that promotes the product or service to the user when the user visits the web site;
presenting questions to the user, wherein the questions relate to the material presented in the material-presenting step;
accepting, from the user, responses to the questions presented in the question-presenting step;
determining whether a response to each of the questions presented in the question-presenting step has been accepted;
notifying the user when a response accepted in the accepting step is incorrect; and
providing a reward to the user if it is determined, in the determining step, that a response has been accepted for each of the questions.

17. The method of claim 16, further comprising the step of informing the user of the correct response when a response accepted in the accepting step is incorrect.

18. The method of claim 16, wherein the inviting step comprises the step of distributing a tangible object upon which a URL for the web site is printed.

19. The method of claim 16, wherein the inviting step comprises the step of sending an email containing a URL for the web site.

20. The method of claim 16, further comprising the step of selecting the product or service that is promoted from a plurality of products and/or services based on a code provided by the user, wherein the selecting step is implemented prior to the material-presenting step.

21. The method of claim 16, further comprising the step of tracking, in a database, the responses accepted in the accepting step.
